(19) United States
(12) Patent Application Publication
(10) Pub. No.: US 2006/0212322 A1
(43) Pub. Date: Sep. 21, 2006

(54) Method and system for purchasing collections of air travel passes

(76) Inventors: Gerald B. Gunn, Vancouver (CA); Charles D. McKee JR., Montreal (CA)

Correspondence Address: PERKINS COIE LLP;PATENT-SEA, P.O. BOX 1247, SEATTLE, WA, 98111-1247, US

(21) Appl. No.: 11/082,184

(22) Filed: Mar. 15, 2005

(51) Int. Cl. G01C 21/34

(52) U.S. Cl. 705/6

(57) ABSTRACT

A method and system for providing a collection of air travel segments and associated travel terms to a user. Different collections of air travel segments are provided to a user. The user selects a collection. The user also selects travel terms including the number of air travel segments to be used and the time period of use. Upon payment, a user may then book flights as long as the flights comply with the collection and travel terms.

### TECHNICAL FIELD

The described technology relates generally to conducting electronic commerce and, more particularly, to purchasing collections of air travel segments.

### BACKGROUND

Because it facilitates electronic communications between vendors and purchasers, the Internet is increasingly being used to conduct “electronic commerce.” The Internet comprises a vast number of computers and computer networks that are interconnected through communication channels. Electronic commerce refers generally to commercial transactions that are at least partially conducted using the computer systems of the parties to the transactions. For example, a purchaser can use a personal computer to connect via the Internet to a vendor's computer. The purchaser can then interact with the vendor's computer to conduct the transaction. The World Wide Web portion of the Internet is especially conducive to conducting electronic commerce. Many web servers have been developed through which vendors can provide and sell services. A user, who is a potential purchaser, may browse through a catalog using a browser and select various services that are then purchased. When the user has completed selecting the services to be purchased, the server computer system then prompts the user for information to complete the ordering of the services. The order information may include the purchaser's name, the purchaser's credit card number, and other identifying information, such as a username. The server computer system then typically confirms the order by sending a confirming web page to the client computer system and schedules the service to be provided to the user.

Many travel service providers (e.g., airlines and travel agencies) offer their travel services via web servers. The services may include selecting and booking flights, checking departure and arrival times, reviewing mileage award status, and so on. To book a flight with an airline via the web, a user visits the reservation web page of the airline. The user then enters a departure city, destination city, departure date, and optionally other criteria such as class of service. The airline's web server identifies the airline's flights that match the criteria and presents the flights to the user. The flight information provided to the user typically includes the departure and arrival times, price, restrictions, number of stops, and so on. The user can then book a flight by selecting it and paying for the flight (e.g., charging it to a credit card account). Alternatively, a user may book a flight using a flight clearinghouse service in much the same way, except that the web server may identify flights of different airlines. Many users will compare flights from competing air travel service providers and purchase air travel based on which flights best meet their needs.

Many people travel frequently between a certain set of locations. For example, a retired person may travel many times during the cold season between their home in a cold climate and their home in warm climate. Such a retired person may want to spend most of the cold season at their home in the warm climate, but may want to spend scheduled time such as holidays and birthdays and unscheduled time such as the birth of a new grandchild at their home in the cold climate. Thus, the retired person will travel between both locations many times throughout the cold season. As another example, a business person may need to travel between the company's home office and one or more satellite offices on a weekly basis. Such travel by the business person may also be on a scheduled or unscheduled basis.

Travel service providers would like to attract and retain the business of such frequent travelers. Although web-based reservation systems have simplified the process of finding and booking flights, it can still be time-consuming for a frequent traveler to find and book the correct flights. Although a frequent traveler may have some incentive (e.g., award miles and schedules) to select one airline over another, many frequent travelers may simply select the flight based solely on cost. It would be desirable for a travel service provider to provide a system so that frequent travelers can more flexibly and easily book travel. Such a system would provide the traveler with an incentive to travel with that travel service provider.

### BRIEF DESCRIPTION OF THE DRAWINGS

FIG. 1 illustrates a display page where a user selects a travel pass and travel terms.

FIG. 2A illustrates a display page of possible travel segments for a selected pass.

FIG. 2B illustrates a display page where a user can select travel segments for a user-specified pass.

FIG. 3 illustrates a display page where a user can purchase a selected pass and travel terms.

FIG. 4 illustrates a display page of a user's flight wallet where a user can book a flight.

FIG. 5 is a block diagram illustrating the system architecture of the travel system.

FIG. 6 illustrates a display page prompting a user to select an associated pass.

FIG. 7 is a flow diagram illustrating the purchasing of a travel pass.

FIG. 8 is a flow diagram illustrating the booking of a flight in the travel system.

### DETAILED DESCRIPTION

A method and system for providing air travel services by which a traveler can purchase a collection of air travel segments and then book flights and travel on those segments in accordance with travel terms is provided. In one embodiment, the travel system provides travel passes that define a collection of air travel segments and travel terms. Each collection includes a set of air travel segments. For example, a “winter getaway” collection may include air travel segments between northern locations (e.g., Montreal) and southern locations (e.g., Miami). The travel terms define the terms of use of a collection of air travel segments. The travel terms may specify the number of times that a traveler is allowed to travel on segments of a collection in a specified period. The travel terms may also specify the start date of the travel. For example, the travel terms may specify that a traveler can travel six segments of a collection during a one-month period starting on Jan. 1. The travel system allows a traveler to purchase a travel pass online by selecting a collection and travel terms and providing payment. After the traveler purchases the travel pass, the traveler can then book flights online by selecting a scheduled flight that corresponds to the collection of air travel segments. If the selected flight is within the travel terms of the pass, the flight is automatically booked. Since the flights that can be purchased under the travel pass are limited to the collection and no additional purchase needs to be made, the booking of flights using a travel pass is simpler than the booking of flights using conventional selection and booking. In addition, the travel service provider may provide a pricing structure for the travel passes that provides an incentive for frequent travelers to purchase travel passes, rather than individual flights. In exchange for a traveler-friendly pricing structure, the traveler may be charged the same purchase price whether the traveler travels the allotted number of times or a lesser number of times. In addition, the travel system may provide a variable pricing structure depending on the number of air travel segments of a travel pass that are actually flown. For example, if the traveler travels more times than allowed under a travel pass, the travel system may charge a reduced price for each additional flight in excess of the allowed number as an incentive to use the same travel service provider.

In one embodiment, the travel system allows a traveler flexibility in creating a travel pass. The travel system may provide a predefined set of collections of travel segments or may allow a traveler to define their own collection of travel segments. A predefined collection may, for example, specify air travel segments between various locations, such as Montreal and Phoenix, Montreal and Miami, Vancouver and Phoenix, and Vancouver and Miami. A traveler may define their own collection of travel segments between various locations such as Montreal and New York and Montreal and Boston. The travel system may also provide a predefined set of travel terms or may allow a traveler to define their own travel terms. A predefined travel set of terms may be, for example, 10, 20, or an unlimited number of flights within one, three, or six months. A traveler may define their own travel terms such as six flights within two months. The travel service provider may allow the traveler to fly on any scheduled flight that complies with the travel pass. A flight complies with the travel pass when it is one of the air travel segments of the collection, within the number of allowed flights and within the time period of the travel pass. The travel system tracks the flights booked by a traveler under the travel system so that it can determine whether subsequent bookings comply with the travel pass.

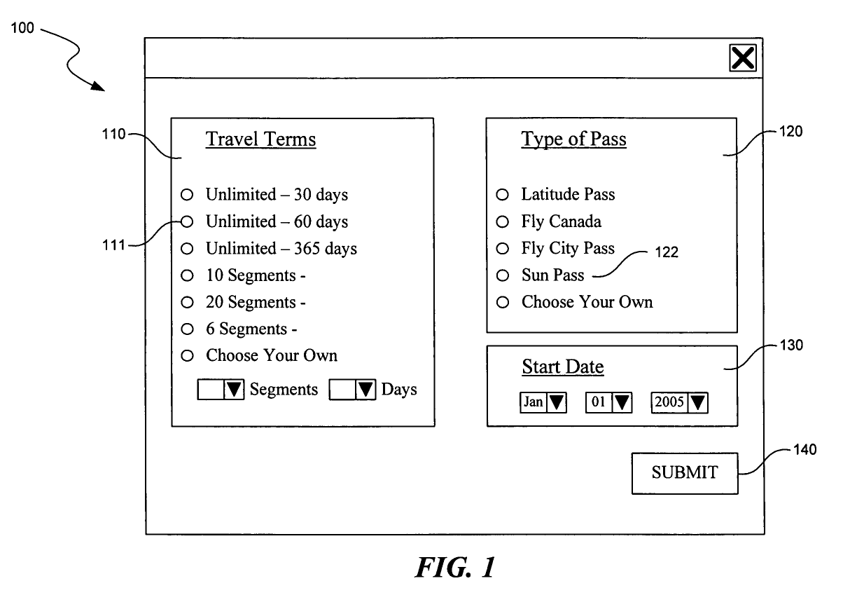

FIG. 1 illustrates a display page 100 where a user selects a travel pass in one embodiment. A traveler uses the display page 100 to select a collection, travel terms, and a start date for the travel pass. The display page 100 includes a list of travel terms 110, a list of collections 120, a start date field 130, and a submit button 140. The travel terms define the maximum number of air travel segments that can be traveled and the time period in which the travel is to take place. The number of segments provided may be fixed (e.g., 6, 10, or 20), user-defined, or unlimited. The time periods provided may be fixed (e.g., 30 days or 365 days) or user-defined (e.g., 45 days). Each predefined collection (e.g., “Sun Pass”) or type of pass defines a specific set of air travel segments. To purchase a travel pass, the traveler selects the time period such as 60 days, selects a number of flights such as 10, selects a type of pass such as Sun Pass 122, selects a start date such as Jan. 1, 2006, and selects the submit button 140. The travel system then displays a web page that allows the traveler to purchase the travel pass.

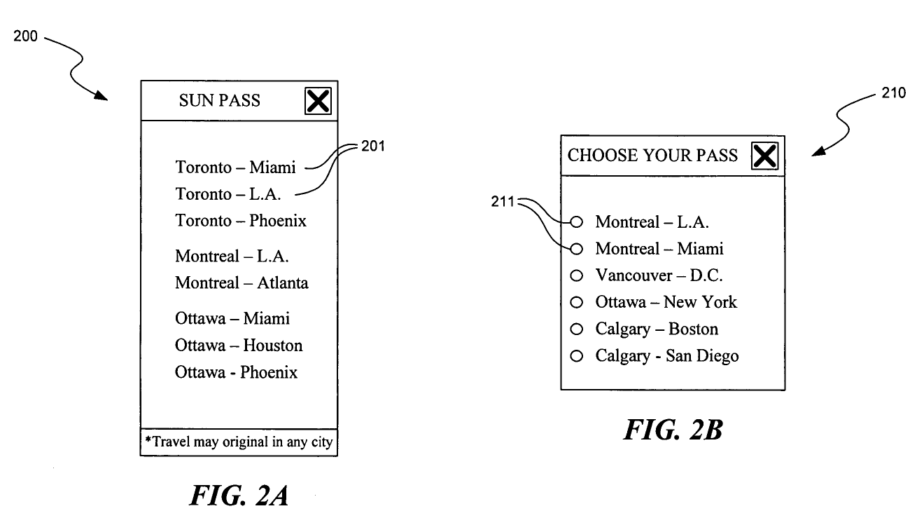

When a traveler selects a type of pass, such as Sun Pass, the travel system displays the travel segments of that type of pass. FIG. 2A illustrates a display page of possible air travel segments 201 for a certain type of pass. When the traveler selects the Sun Pass 122 of FIG. 1, the travel system displays display page 200. The display page lists the air travel segments 201 for a travel pass of that type. For example, the display page indicates that the Sun Pass includes air travel segments between Toronto and Miami, Toronto and Los Angeles, Toronto and Phoenix, and so on.

Referring again to FIG. 1, the travel system may allow the user to define the air travel segments of their travel pass. When the traveler selects the “choose your own” option of FIG. 1, the travel system allows the traveler to select the air travel segments of the travel pass. FIG. 2B illustrates a display page 210 where a traveler can select air travel segments 211 for a traveler-defined collection. The traveler can select one or more of the air travel segments.

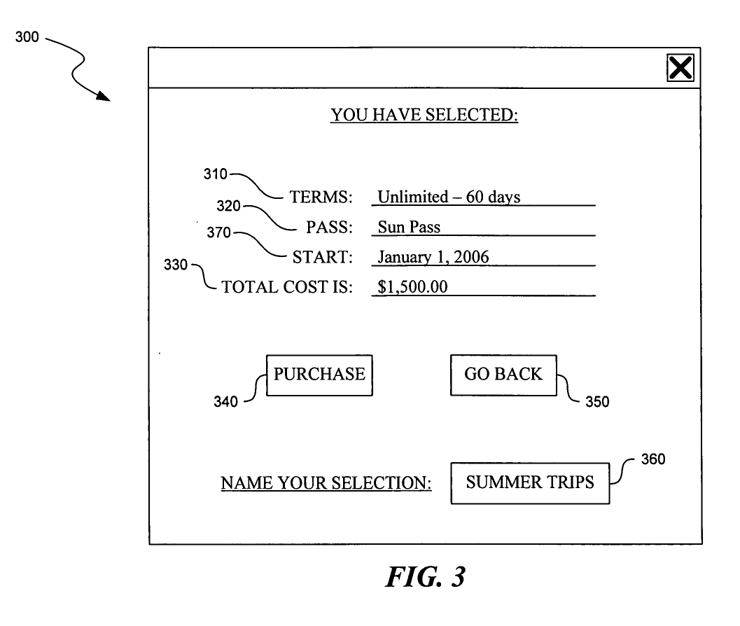

FIG. 3 illustrates a display page where a traveler can purchase a selected pass and travel terms. Upon the traveler's selection of a pass type, travel terms, and start date from display page 100, the travel system presents a display page 300 to the traveler. The display page shows selected travel terms 310, a selected pass type 320, a start date 370, and a calculated price 330 for the travel pass. The travel system calculates the price based on the number of segments, the time period, the start date, and the type of pass. The traveler can then decide to purchase the travel pass by selecting a purchase button 340 or can decide to go back and redefine the travel pass by selecting a button 350. Also, the traveler may wish to name the travel pass being purchased for easy reference in case the traveler purchases multiple travel passes. Before purchasing, the traveler may enter the travel pass name in a field 360 such as “Summer Trips.”

The travel system may allow the traveler to purchase the travel pass using standard e-commerce techniques. The traveler may be asked for traveler information (e.g., name and address) and payment information (e.g., credit card number). Upon successful purchase of a travel pass, the traveler system then assigns the travel pass to the traveler and maintains information about the travel pass including pass type, travel terms, and usage.

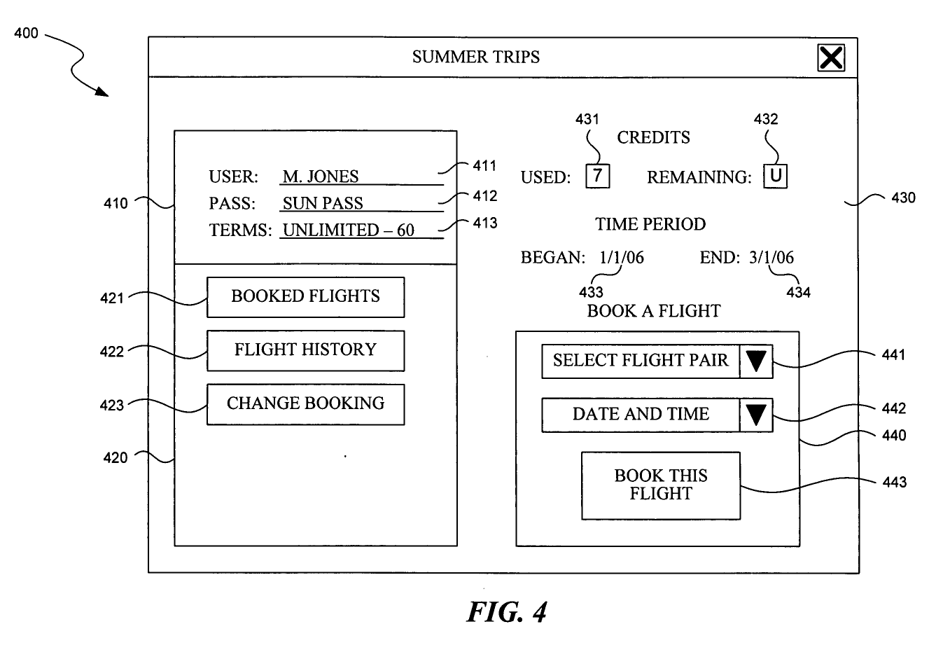

FIG. 4 illustrates a display page of a traveler's information through which a traveler can book a flight using a travel pass in one embodiment. A display page 400 shows the information associated with a travel pass that the traveler has purchased. The display page 400 contains traveler information 410, traveler flight information 420, travel terms information 430, and a flight booking function 440. The traveler information contains the traveler's name 411, type of pass 412, and travel terms 413. The traveler flight information 420 contains currently booked flights 421, a history of previously traveled flights 422, and a function to change a previously booked flight 423. The travel terms information 430 contains an indication of credits used (i.e., air travel segments flown) 431, credits remaining (i.e., air travel segments remaining) 432, and a start date 433 and an end date 434 of the time period for the pass.

The flight booking function 440 allows the user to book a flight on the travel pass. The function displays available city pairs 441 and specific flight information 442 for a selected city pair. Alternatively, the travel system may use a conventional user interface for a selection of flights limited to the available city pairs and, after a flight is selected, automatically recording that a flight has been booked and updating the travel pass information accordingly.

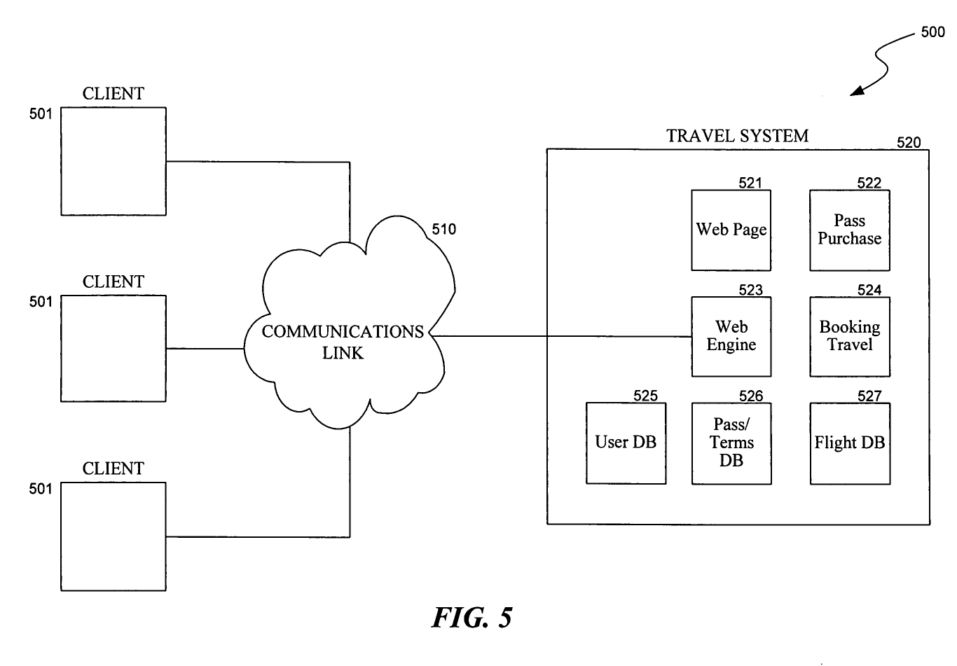

FIG. 5 is a block diagram 500 illustrating the system architecture of the travel system in one embodiment. Client computers 501 and a travel system 520 are interconnected via communication link 510, such as the Internet. The computers may include a central processing unit, memory, input devices (e.g., keyboard and pointing device), output devices (e.g., display devices), and storage devices (e.g., disk drive). The memory and storage devices are computer-readable media that may contain computer instructions that implement the travel system. The travel system may include web pages 521, a pass purchase component 522, a web engine 523, a travel booking component 524, a traveler database 525, a travel pass database 526, and a flight database 527. In addition, the data structures and message structures may be stored or transmitted via a computer readable medium, such as a communication link 510.

The client computers may use browsers to access display pages of the travel system via the Internet. The web engine receives requests for display pages from the client computers, coordinates the generation of the requested display page, and provides the requested display page to the requesting client computer. The pass purchase component provides the functions through which a traveler can purchase a travel pass. The travel booking component 524 provides the functions through which a traveler can book a flight on a travel pass. The traveler database identifies information about the travelers. The travel pass database identifies previous travel passes that have been purchased by the travelers and may contain information describing the predefined pass types, travel terms, and so on. The flight database may correspond to a conventional database containing flight schedule and flight booking information. In one embodiment, the travel system may interface to a conventional flight booking system so that flights booked using a travel pass are handled like flights booked via a conventional flight booking system.

Embodiments of the travel system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The travel system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. One skilled in the art will appreciate that the concepts of the travel system can be used in many different environments.

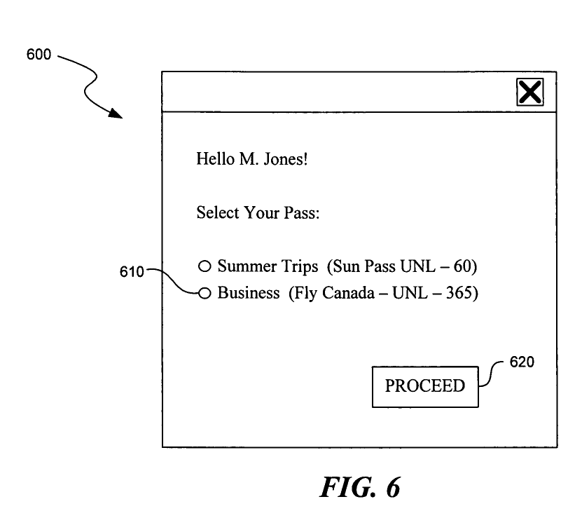

FIG. 6 illustrates a display page 600 prompting a traveler to select an associated pass in one embodiment. A traveler may be associated with more than one travel pass such as one for business travel and one for personal travel. In this example, in order to book a flight, a traveler is first requested to select a travel pass 610 to be used to purchase a business flight. Upon selection of the travel pass 610, the user can then proceed to book a flight by selecting a button 620.

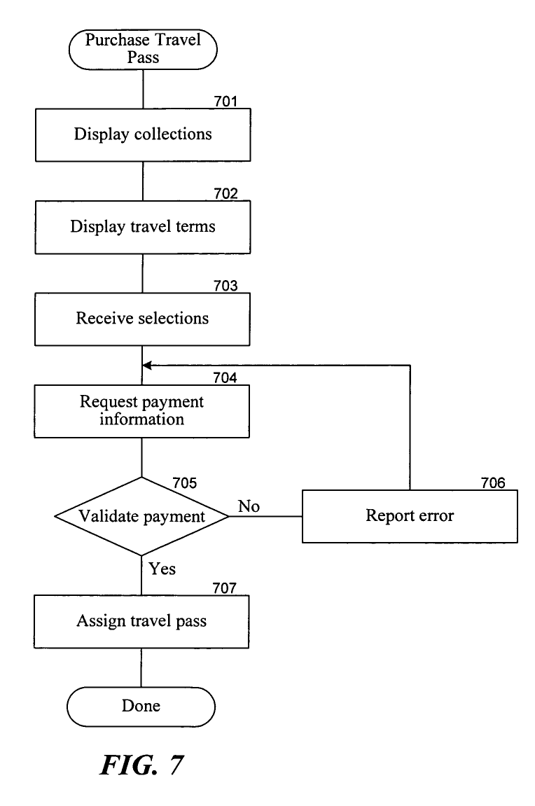

FIG. 7 is a flow diagram that illustrates the processing of the purchasing travel component of the travel system in one embodiment. The component is passed an indication of a traveler and coordinates purchasing of a travel pass. In block 701, the component displays collections of air travel segments that are available to the traveler. In one embodiment, some travelers may have different types of passes available to them. For example, a corporation may negotiate with a travel service provider to provide certain collections for its employees. In block 702, the component displays a list of travel terms that the traveler can select to go with the selected collection. In block 703, the component receives a selection of a collection and a selection of travel terms from the traveler that define the travel pass. In block 704, the component requests payment information from the traveler for the selected collection and travel terms. In decision block 705, if the payment information is valid, then the component continues at block 707, else the component reports an error in block 706 and loops to block 704 to allow the traveler to re-enter payment information. In block 707, the component assigns a travel pass to the traveler identifying the collection of air travel segments and travel terms and then completes.

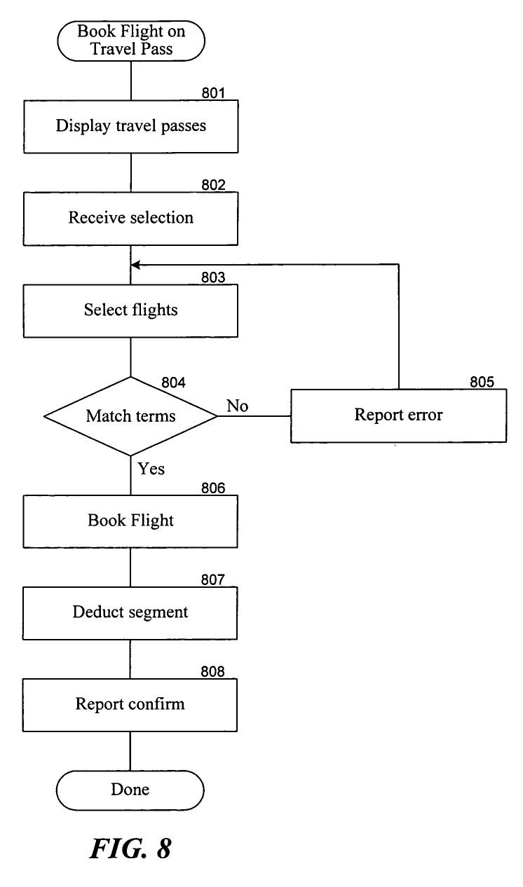

FIG. 8 is a flow diagram that illustrates the processing of the book travel component of the travel system in one embodiment. The component is passed an indication of the traveler and coordinates booking of a flight for that traveler using a travel pass that the traveler previously purchased. In block 801, the component displays the travel passes that the traveler has purchased. In block 802, the component system receives the selection of a travel pass from the traveler. In block 803, the component receives a selection of a flight from the traveler for an air travel segment of the travel pass. In decision block 804, if the selected flight complies with the travel pass, then the component continues at block 806, else the component reports an error in block 805 and loops to block 803 to allow the traveler to select another flight. In block 806 the component books the selected flight for the traveler. In block 807, the component adjusts the information of the travel pass to indicate that the traveler has booked the flight. In block 808, the component displays a confirmation of the booking to the traveler and then completes.

The travel system may be modified to provide different incentives to different classes of travelers. In one embodiment, the travel system provides travel terms with a fixed number of flights. For example, a traveler may purchase a 10-flight travel pass for air travel segments between three city pairs, to be used within one year. For each flight taken, the travel system deducts flights from the travel pass. In addition, the traveler may be eligible for class upgrades and may receive bonus miles for the initial purchase of the travel pass.

In another embodiment, the travel system provides a travel pass with an unlimited number of flights on air travel segments of the collection (e.g., all pairs of cities in a country) for a single traveler within a certain time period. The traveler can travel on any air travel segment at any time within the time period. The traveler may also choose a class of travel, or may be eligible to upgrade at a later time.

In another embodiment, the travel system provides a travel pass that allows anyone in a family to travel on the travel pass. The pass could have a fixed amount of flights for a certain time period.

In another embodiment, the travel system allows the traveler to determine the number of flights and time period a travel pass is good for. For example, the traveler may purchase 25 flights for the following year. The travel system may allow the traveler to purchase additional flights for a travel pass.

In another embodiment, the travel system may provide a corporate pass type that allows various employees (of the corporation or other organization) to travel under the same travel pass. The company could modify the list of travelers and could purchase additional flights. The cost of the additional flights may vary based on the time remaining in the travel terms. The travel system may also allow a traveler to purchase more time on a travel pass.

From the foregoing, it will be appreciated that specific embodiments of the travel system have been described herein for purposes of illustration, but that various modifications may be made without deviating from the spirit and scope of the invention. Accordingly, the invention is not limited except as by the appended claims.

I/We claim:

1. A method in a computer system for providing air travel services, the method comprising:
providing collections of air travel segments;
providing travel terms defining terms of use of a collection of air travel segments by which a user can travel on any air travel segment of the collection with a specified period;
receiving from a user a selection of a collection and travel terms;
receiving from the user a request to book travel on a flight of an air travel segment of the selected collection; and
when the request to book is in accordance with the selected travel terms, booking the user to travel on the requested flight.

2. The method of claim 1 wherein the travel terms specify a maximum number of flights that can be traveled during the specified period.

3. The method of claim 1 wherein the travel terms specify that an unlimited number of flights can be traveled during the specified period.

4. The method of claim 1 wherein the travel terms can be determined by the user.

5. The method of claim 1 wherein the air travel segments associated with a collection can be determined by the user.

6. The method of claim 1 wherein the travel terms and the air travel segments associated with a collection can be determined by the user.

7. A method in a computer system for providing air travel services, the method comprising:
providing collections of air travel segments;
providing travel terms defining terms of use of a collection of air travel segments by which a user can travel on any air travel segment of the collection with a specified period; wherein the travel terms specify an unlimited number of air travel segments within a specified period;
receiving from a user a selection of a collection and travel terms;
receiving from the user a request to book travel on an air travel segment of the selected collection; and
when the request to book is in accordance with the selected travel terms, booking the user to travel on the requested air travel segment.

8. The method of claim 7 wherein the air travel segments associated with a collection can be determined by the user.

9. The method of claim 7 wherein a certain number of users can travel under the travel terms.

10. A method in a computer system for providing air travel services, the method comprising:
providing collections of air travel segments;
providing travel terms defining terms of use of a collection of air travel segments;
receiving from a user a selection of a collection and travel terms and a payment for traveling on the air travel segments of the selected collection in accordance with the selected travel terms; and after receiving the selection and payment,
receiving from the user a request to book travel on an air travel segment of the selected collection; and
when the request to book is in accordance with the selected travel terms, booking the user to travel on the requested air travel segment.

11. The method of claim 10 wherein the travel terms specify a maximum number of air travel segments that can be traveled during the specified period.

12. The method of claim 10 wherein the travel terms specify an unlimited number of air travel segments that can be traveled during the specified period.

13. The method of claim 10 wherein the travel terms can be determined by the user.

14. The method of claim 10 wherein the air travel segments associated with a collection can be determined by the user.

15. The method of claim 10 wherein the travel terms and the air travel segments associated with a collection can be determined by the user.
